(19) United States
(12) Patent Application Publication
(10) Pub. No.: US 2026/0249494 A1
(43) Pub. Date: Aug. 27, 2026

(54) PRODUCE SCISSORS WITH STABILIZING HANDHELD CUTTING BOARD

(71) Applicant: MFalcon LLC, Henderson, NV (US)

(72) Inventor: Diana Davidow, Denver, CO (US)

(73) Assignee: MFalcon LLC, Henderson, NV (US)

(21) Appl. No.: 19/063,024

(22) Filed: Feb. 25, 2025

(51) Int. Cl. B26B 13/22; B26B 13/08; B26B 13/20

(52) U.S. Cl. CPC B26B 13/22; B26B 13/08; B26B 13/20

(57) ABSTRACT

Scissors for cutting produce include a handled cutting board having a body with a plurality of curved recesses spaced along a length of the body, and dimensioned to securely hold at least a portion of spheroid-shaped produce during cutting. The scissors further include a handled blade pivotally connected to the handled cutting board and movable in a blade plane to perform a scissors action relative to the handled cutting board. The scissors further include a shaft assembly connecting the handled cutting board to the handled blade and facilitating pivotal movement of the handled blade with respect to the handled cutting board.

### BACKGROUND OF THE INVENTION

### Field of the Invention

The present disclosure relates generally to scissors and, more particularly, to scissors designed to stabilize small produce items during cutting.

### Description of the Related Art

Scissors (or shears) are widely recognized as versatile tools in kitchen and food preparation settings. They are commonly used for tasks ranging from cutting herbs to trimming meat, offering a level of precision and control that is often preferred over knives in certain contexts. Scissors may provide several advantages over knives, particularly when dealing with smaller food items. For instance, the dual-blade design and manual operation of scissors can allow for improved efficiency and accuracy, reducing the risk of injury compared to using a sharp knife on a cutting board.

Despite these advantages, traditional scissors face significant limitations when applied to certain types of food items. Specifically, food items that are inherently round, slippery, or otherwise difficult to stabilize—such as cherry tomatoes, grapes, and similar small produce—present unique challenges. These challenges include difficulty in securing the food item during the cutting process, resulting in unintended movement or inconsistent cuts. Additionally, attempts to stabilize these items manually or with auxiliary tools can introduce safety risks or inefficiencies, particularly in high-volume or repetitive cutting scenarios.

### SUMMARY OF THE INVENTION

Embodiments of scissors for cutting produce are described herein. In one embodiment, the scissors include a handled cutting board having a body with a plurality of curved recesses spaced along a length of the body, each curved recess dimensioned to securely hold at least a portion of spheroid-shaped produce during cutting. The scissors further include a handled blade pivotally connected to the handled cutting board, the handled blade being movable in a blade plane to perform a scissors action relative to the handled cutting board. The scissors further include a shaft assembly connecting the handled cutting board to the handled blade, the shaft assembly facilitating pivotal movement of the handled blade with respect to the handled cutting board.

In another embodiment, the scissors include a handled cutting board. The scissors further include a handled blade pivotally connected to the handled cutting board, the handled blade being movable in a blade plane to perform scissors action relative to the handled cutting board. The scissors further include a shaft assembly fastening the handled cutting board to the handled blade, the shaft assembly allowing pivotal movement of the handled blade. In some implementations, the body of the handled cutting board includes a plurality of tapered apertures spaced along a length thereof, each tapered aperture dimensioned to partially retain spheroid-shaped produce within the body of the handled cutting board during cutting by the scissors action with the handled blade.

The foregoing summary has been provided to introduce a selection of concepts in a simplified form that are further described below in the detailed description. The summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustration of scissors for cutting produce, according to one embodiment of the invention;

FIG. 2 is a top perspective view illustration of the scissors for cutting produce, according to one embodiment of the invention;

FIG. 3 is a bottom perspective view illustration of the scissors for cutting produce, according to one embodiment of the invention;

FIG. 4 is a side view illustration of the scissors for cutting produce, according to one embodiment of the invention;

FIG. 5 is an additional side view illustration of the scissors for cutting produce, according to one embodiment of the invention;

FIG. 6 is a top view illustration of the scissors for cutting produce, according to one embodiment of the invention; and

FIG. 7 is a bottom view illustration of the scissors for cutting produce, according to one embodiment of the invention.

### DETAILED DESCRIPTION OF THE DRAWINGS

The following detailed description of the invention merely provides exemplary embodiments and is not intended to limit the invention of the application and uses of the invention. Furthermore, there is no intention to be bound by any theory presented in the preceding background of the invention of the following detailed description of the invention.

As mentioned previously, scissors (or shears) are widely recognized as versatile tools in kitchen and food preparation settings. Scissors may provide several advantages over knives, particularly when dealing with smaller food items. For instance, the dual-blade design and manual operation of scissors can allow for improved efficiency and accuracy, reducing the risk of injury compared to using a sharp knife on a cutting board.

Despite these advantages, traditional scissors face significant limitations when applied to certain types of food items. Specifically, food items that are inherently round, slippery, or otherwise difficult to stabilize—such as cherry tomatoes, grapes, and similar small produce—present unique challenges. These challenges include difficulty in securing the food item during the cutting process, resulting in unintended movement or inconsistent cuts. Additionally, attempts to stabilize these items manually or with auxiliary tools can introduce safety risks or inefficiencies, particularly in high-volume or repetitive cutting scenarios.

The inability of traditional scissors to address these challenges has led to reliance on alternative methods, such as using knives with a stabilizing cutting board, which may sacrifice the convenience and ergonomic benefits that scissors provide. This unmet need illustrates the demand for a tool that combines the ease of use and safety features of scissors with specialized adaptations to effectively handle small, unstable food items. Addressing these limitations would improve not only the functionality of scissors in the kitchen but also the overall user experience in food preparation.

Accordingly, the present innovation addresses these drawbacks by integrating a handled cutting board having curved recesses spaced thereon designed to stabilize small, round food items during cutting. The cutting board provides a firm, secure surface, while the curved recesses hold individual food items in place, preventing movement and ensuring precise cuts. This design not only improves safety by reducing the likelihood of slippage but also enhances efficiency by allowing users to cut multiple items quickly and uniformly. Furthermore, the handled nature of the cutting board integrated with the scissors action facilitates ease of use, portability, and storage, making the scissors a versatile and ergonomic tool for various food preparation tasks.

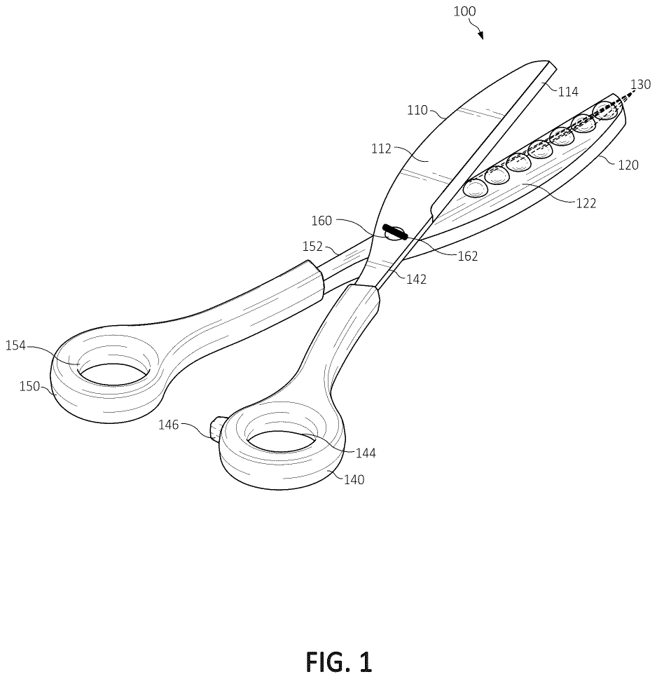

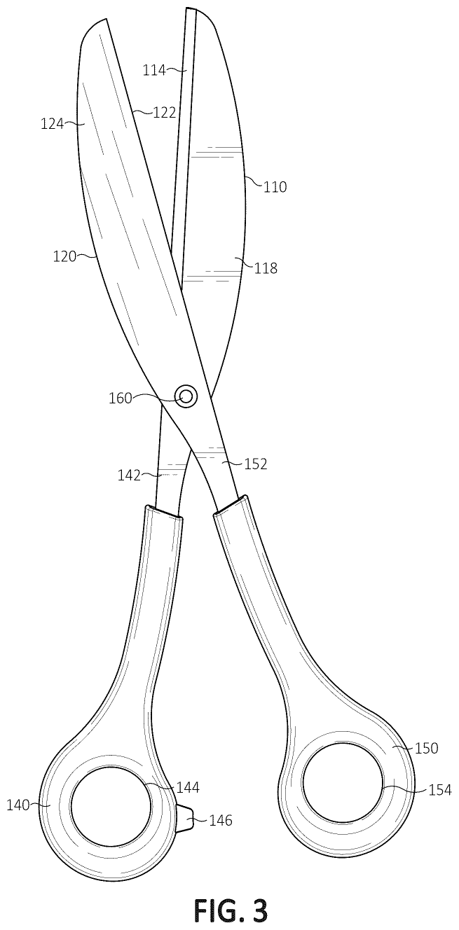

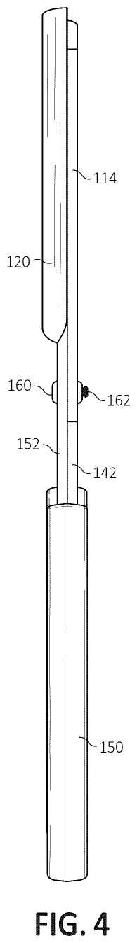

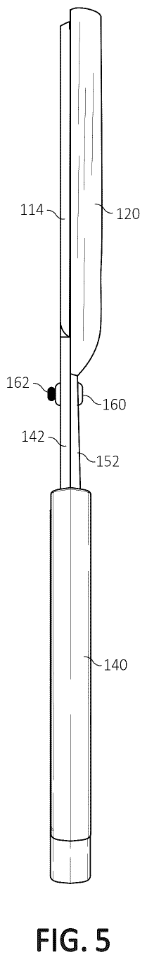

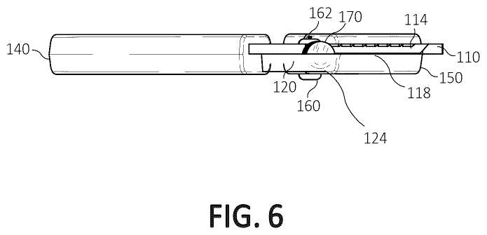

Referring now to the drawings, FIGS. 1-7 illustrate scissors for cutting produce (more simply referred to herein as simply “scissors”) 100. The scissors include a handled blade (or “blade”) 110, a handled cutting board (or “cutting board”) 120, and a shaft assembly 160 to facilitate pivoted cutting motion. The blade 110, the cutting board 120, and the shaft assembly 160 work in conjunction to achieve scissors action, where the blade 110 moves relative to the cutting board 120 to sever spheroid-shaped produce securely held within a body of the cutting board 120.

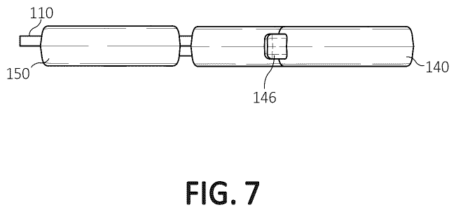

In one embodiment, the cutting board 120 incorporates a plurality of concave recesses (or “recesses”) 130. The concave recesses 130 are machined into a top side 122 (opposite a bottom side 124) of the body of the cutting board 120 and are spaced evenly along its longitudinal axis. Each recess 130 has a circular base profile, forming a hemispherical depression with a diameter between ½ inch and 1½ inches and a depth ranging from ¼ inch to ½ inch such that the recesses 130 do not penetrate the bottom side 124 of the cutting board 120. The dimensions are selected to accommodate spheroid-shaped produce 170 (e.g., a cherry tomato depicted in FIG. 7), ensuring a snug fit to prevent lateral or rotational movement. The recesses 130 may be constructed with a smooth surface finish to minimize friction and reduces the risk of damage to delicate produce skins, and a curved geometry of the recesses is engineered to distribute holding forces evenly around the produce 170. In various embodiments, the cutting board 120 is fabricated from a rigid, food-safe material, such as thermoplastic polymer.

The handled blade 110 in this embodiment is pivotally mounted to the cutting board 120 using the shaft assembly 160, which serves as the rotational axis of the scissors 100. The shaft assembly 160 may consist of a precision-machined pin (e.g., a stainless-steel pin) that passes through aligned bores in the proximal ends of the blade 110 and cutting board 120. The pin may be secured in place with interference fits or locking clips, ensuring smooth and controlled pivoting with minimal play.

In one embodiment, the shaft assembly 160 includes a locking mechanism 162 configured to selectively release the cutting board 120 from the blade 110 at the pivot point of the shaft assembly 160. For example, the locking mechanism 162 may comprise a quarter-turn screw or cam mechanism (e.g., a pivot screw with a cam or bayonet-style design allows the user to lock or unlock it with a quarter or half-turn), thumb screw, push-button release mechanism (e.g., a spring-loaded button integrated into the pivot pin locks the blade 110 and cutting board 120 when pressed, and allows disassembly or blade replacement when released), slip joint with locking pin, or the like.

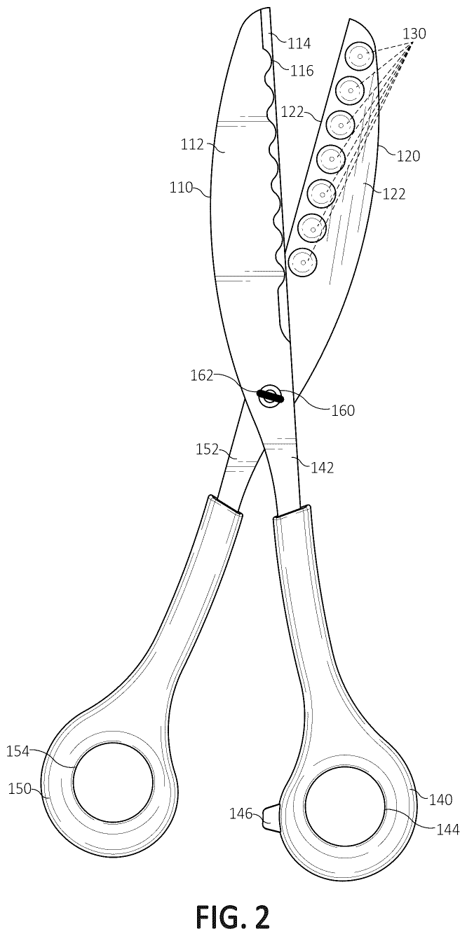

The handled blade 110, having a top side 112 and a bottom side 118, may be planar and rectangular, with a cutting edge 114. In one embodiment the cutting edge 114 is a straight blade (depicted in FIG. 1). In another embodiment, the cutting edge 114 may feature a scalloped edge 116 profile (depicted in FIG. 2). The scalloped edge 116 may comprise alternating convex arcs and concave notches, creating a series of points and valleys along the blade 110's length. This design may reduce the force required to penetrate the produce by concentrating the applied force at the points of contact, resulting in cleaner cuts with reduced deformation of the produce 170. The blade 110 may be constructed from hardened stainless-steel, or other hard metal, to provide a durable, sharp edge with resistance to corrosion and wear.

The blade 110 includes handle 150 and the cutting board 120 includes handle 140, each handle 140, 150 being ergonomically designed for user interaction. The handles 140, 150 are respectively positioned at the distal ends of the blade 110 and the cutting board 120, opposite the shaft assembly 160. Each handle 140, 150 respectively includes a shank 142, 152 and a finger loop 144, 154, which together form an ergonomic gripping surface. In one implementation, handle 140 may include a handle stop 146 and/or a finger catch (not depicted) for facilitating ease of use.

In one embodiment, one or both finger loops 144, 154 are circular, designed to accommodate a variety of finger sizes, and are shaped with rounded edges to prevent discomfort during prolonged use. In another embodiment, one or both finger loops (e.g., finger loop 144) may be constructed with an oval or elliptical profile, for example.

The shanks 142, 152 respectively extend linearly from the finger loops 144, 154 to the main body of the cutting board 120 and blade 110, providing a rigid connection that transmits user-applied forces to perform the scissors action efficiently. In one embodiment, the handles 140, 150 may each be angled slightly relative to the cutting plane to improve leverage during operation of the scissors 100.

In one embodiment, in place of the concave recesses 130 of the cutting board 120, the recesses 130 instead comprise tapered apertures (not depicted) that pass through the cutting board 120. Each tapered aperture may be formed as a conical through-hole, with the top opening (on the top side 122 of the cutting board 120) larger than the bottom (on the bottom side 124 of the cutting board 120). The top diameter of each aperture may range from ½ inch to 1½ inches, while the bottom diameter is proportionally smaller, determined by a taper angle optimized for produce retention. The taper creates a constriction that securely holds the spheroid-shaped produce 170 within the aperture, while a flared profile of each taper accommodates slight variations in produce size.

In operation of the scissors 100, a user places the produce 170 into one of the concave recesses 130 (or tapered apertures), where the produce 170 is cradled securely. The user inserts their fingers into the finger loops 144, 154 and applies bias to bring the handles 140, 150 together, which pivots the blade 110 downward in its blade plane, cutting through the produce 170 with the cutting edge 114 and/or the scalloped edge 116. For cleaning the scissors 100, the user may release the blade 110 from the cutting board 120 by operation of the locking mechanism 162 of the shaft assembly 160.

It should be noted that, as used herein, the terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. Scissors for cutting produce, the scissors comprising:
a handled cutting board having a body with a plurality of curved recesses spaced along a length of the body, each curved recess dimensioned to securely hold at least a portion of spheroid-shaped produce during cutting;
a handled blade pivotally connected to the handled cutting board, the handled blade being movable in a blade plane to perform a scissors action relative to the handled cutting board; and
a shaft assembly connecting the handled cutting board to the handled blade, the shaft assembly facilitating pivotal movement of the handled blade with respect to the handled cutting board;
wherein the curved recesses are configured to partially secure the spheroid-shaped produce within the body of the handled cutting board.

2. The scissors for cutting produce of claim 1, wherein each of the plurality of curved recesses comprises a concave recess.

3. The scissors for cutting produce of claim 1, wherein each of the plurality of curved recesses has a diameter between ½ inch and 1½ inches.

4. The scissors for cutting produce of claim 1, wherein each of the plurality of curved recesses has a depth of between ¼ inch and ½ inch.

5. The scissors for cutting produce of claim 1, wherein the handled blade includes a scalloped blade edge.

6. The scissors for cutting produce of claim 1, wherein the handled cutting board is composed of a rigid, food-safe plastic material.

7. The scissors for cutting produce of claim 1, wherein the handled cutting board has substantially a same width and length as the handled blade.

8. The scissors for cutting produce of claim 1, wherein the shaft assembly is located at a pivot point between the handled cutting board and the handled blade, and the shaft assembly includes a locking mechanism configured to selectively release the handled cutting board from the handled blade at the pivot point.

9. The scissors for cutting produce of claim 1, wherein the handled cutting board and the handled blade each include a shank and finger loop for facilitating the scissors action.

10. Scissors for cutting produce, the scissors comprising:
a handled cutting board;
a handled blade pivotally connected to the handled cutting board, the handled blade being movable in a blade plane to perform scissors action relative to the handled cutting board; and
a shaft assembly fastening the handled cutting board to the handled blade, the shaft assembly allowing pivotal movement of the handled blade;
wherein a body of the handled cutting board includes a plurality of tapered apertures spaced along a length thereof, each tapered aperture dimensioned to partially retain spheroid-shaped produce within the body of the handled cutting board during cutting by the scissors action with the handled blade.

11. The scissors for cutting produce of claim 10, wherein each of the plurality of tapered apertures comprises a flared taper having an outer diameter on a side of the body closest to a cutting edge of the handled blade.

12. The scissors for cutting produce of claim 11, wherein the outer diameter of each tapered aperture is between ½ inch and 1½ inches.

13. The scissors for cutting produce of claim 10, wherein each of the plurality of tapered apertures forms a through hole in the handled cutting board.

14. The scissors for cutting produce of claim 10, wherein the handled blade includes a scalloped cutting edge.

15. The scissors for cutting produce of claim 10, wherein handled cutting board is composed of a rigid, food-safe plastic material.

16. The scissors for cutting produce of claim 10, wherein the handled cutting board has substantially a same width and length as the handled blade.

17. The scissors for cutting produce of claim 10, wherein the shaft assembly is located at a pivot point between the handled cutting board and the handled blade, and the shaft assembly includes a locking mechanism configured to selectively release the handled cutting board from the handled blade at the pivot point.

18. The scissors for cutting produce of claim 10, wherein the handled cutting board and the handled blade each include a shank and finger loop for facilitating the scissors action.
